(19) United States
(12) Patent Application Publication
(10) Pub. No.: US 2012/0154314 A1
(43) Pub. Date: Jun. 21, 2012

(54) ELECTRONIC DEVICE AND COMMUNICATION SYSTEM HAVING A FILE TRANSMISSION FUNCTION, AND A RELATED FILE TRANSMISSION METHOD

(75) Inventor: JU-QIANG WU, Nanjing (CN)

(73) Assignees: INVENTEC APPLIANCES (SHANGHAI) CO. LTD., Shanghai (CN); INVENTEC APPLIANCES CORP., NANJING, Nanjing (CN); INVENTEC APPLIANCES CORP., New Taipei City (TW)

(21) Appl. No.: 13/329,171

(22) Filed: Dec. 16, 2011

(30) Foreign Application Priority Data
Dec. 17, 2010 (CN) 201010612215.0

(51) Int. Cl. G06F 3/041

(52) U.S. Cl. 345/173

(57) ABSTRACT

An electronic device and a communication system having a file transmission function, and a related file transmission method are disclosed. The method includes the following steps: a first touch screen displaying an icon associated with the file; the first touch screen receiving a touch scroll outward movement by a first object from an interior on the first touch screen, and generating a first touch signal in response; a first control module issuing a signal of transmitting according to the first touch signal; a second touch screen receiving a touch scroll inward movement by a second object from an outer part on the second touch screen, and generating a second touch signal in response; a second control module issuing a response signal according to the second touch signal and the signal of transmitting; the first control module transmitting the file to the second control module, upon receiving the response signal.

### CROSS-REFERENCE TO RELATED APPLICATION

This application claims the benefit of China Patent Application No. 201010612215.0, filed on Dec. 17, 2010, in the State Intellectual Property Office of the People's Republic of China, the disclosure of which is incorporated in its entirety by reference.

### BACKGROUND OF THE INVENTION

1. Field of the Invention

The present invention relates generally to an electronic device, a communication system, and a file transmission method and, more particularly, to an electronic device capable of communicating a file with another electronic device, a communication system having a file transmission function, and a related file transmission method, in which a file is communicated by an intuitive touch scroll movement on a touch screen.

2. Description of the Related Art

As the technology of electronic devices becomes increasingly more mature, more services are provided by the electronic devices, and it is a common function to transmit files among the electronic devices.

However, the conventional file transmission method between the electronic devices still requires operations through a menu. For example, a user selects at least one file first, and then selects a desired transmitting target device, and such process is cumbersome and not intuitive. In addition, increasingly more data sharing and transmissions between the electronic devices are required as the science and technology advance, and thus the drawbacks of the conventional file transmission method still exist.

In summation of the description above, the inventor of the present invention designed an electronic device, a communication system having a file transmission function and a file transmission method to overcome the drawbacks of the conventional file transmission method and provided an intuitive dragging operation for the file transmission between the electronic devices to improve the practicality of its industrial applications.

### SUMMARY OF THE INVENTION

In view of the shortcomings of the prior art, it is an objective of the present invention to overcome the problem that the conventional file transmission process is complicated and tedious, by providing an electronic device, a communication system having file transmission function, and a file transmission method in accordance with the present invention.

To achieve the aforementioned objective, the present invention provides a communication system having a file transmission function, the communication system comprising a first touch screen, a first control module, a second touch screen and a second control module. The first touch screen is coupled to first control module, and the second touch screen is coupled to the second control module. The first touch screen is provided for displaying an icon associated with a file and generating a first touch signal after a first object receives a touch scroll outward movement from the first touch screen. The first control module issues a signal of transmitting to the second control module according to the first touch signal. The second touch screen generates a second touch signal after a second object receives a touch scroll inward movement from the second touch screen. The second control module issues a response signal to the first control module according to the second touch signal and the signal of transmitting. When the first control module receives the response signal, the first control module transmits the file to the second control module.

In an embodiment, the communication system having a file transmission function may further comprise a first communication module and a second communication module. The first communication module may be coupled to the first control module, and the first control module may transmit the file to the second control module through the first communication module. The second communication module may be coupled to the second control module, and the second control module may receive the file through the second communication module.

In an embodiment, the first communication module may communicate with the second communication module under at least one of Bluetooth, an infrared communication technology standard, a wireless local area network (WLAN) standard, or a wireless fidelity (Wi-Fi) standard.

In an embodiment, after the first touch screen receives a scroll movement of a first object from a first center point of the first touch screen to an edge of the first touch screen, a first touch signal may be generated.

In an embodiment, after the second touch screen receives a scroll movement of a second object from a second center point of the second touch screen to an edge of second touch screen, a second touch signal may be generated.

To achieve the aforementioned objective, the present invention further provides a file transmission method, applicable to a first electronic device and a second electronic device. The first electronic device includes a first touch screen and a first control module; and the second electronic device includes a second touch screen and a second control module. The file transmission method comprises the following steps: Firstly, the first touch screen displays an icon associated with a file. Secondly, when the first touch screen receives a scroll outward movement of a first object on the first touch screen, a first touch signal is generated. And then, the first control module is provided for issuing a signal of transmitting according to the first touch signal. After the second touch screen receives a touch scroll inward movement by a second object on the second touch screen, a second touch signal is generated. The second control module is used for issuing a response signal according to the second touch signal and the signal of transmitting. Finally, after the first control module receives a response signal, the file is sent to the second control module.

In an embodiment, the file transmission method may further comprise the step of transmitting the file through a first communication module and may receive the file through a second communication module.

In an embodiment, the first communication module may communicate with the second communication module under at least one of Bluetooth, an infrared communication technology standard, a wireless local area network (WLAN) standard, or a wireless fidelity (Wi-Fi) standard.

In an embodiment, the step of generating the first touch signal by the first touch screen may further comprise the step of generating a first touch signal after the first touch screen receives a scroll movement of a first object from a first center point of the first touch screen to an edge of the first touch screen.

In an embodiment, the step of generating a second touch signal by the second touch screen may further comprise the step of generating a second touch signal after the second touch screen receives a scroll movement of the second object from an edge of the second touch screen to a position near a second center point of the second touch screen.

In the file transmission method and the communication system having a file transmission function in accordance with the present invention, the first control module may be used for transmitting a file according to the touch scroll outward movement of an object on the first touch screen and the second control module may be used for receiving a file according to the touch scroll inward movement of an object on the second touch screen, such that the files can be transmitted intuitively more convenient.

To achieve the aforementioned objective, the present invention further describes a first electronic device capable of communicating a file with a second electronic device, wherein the first electronic device comprises a first touch screen and a first control module. The first touch screen is configured to display an icon associated with a file, and to generate a first touch signal in response to receiving a touch scroll outward movement by a first object from an interior on the first touch screen. The first control module is coupled to the first touch screen and configured to issue a signal of transmitting according to the first touch signal, wherein the first control module is configured to transmit the file to the second electronic device upon receiving a response signal issued by the second electronic device according to the signal of transmitting. In the first electronic device, the first touch screen is also configured to generate a second touch signal in response to receiving a touch scroll inward movement by the first object from an outer part on the first touch screen, and the first control module is also configured to issue a response signal according to the second touch signal and a signal of transmitting issued by the second electronic device, and wherein the first control module is configured to receive the file from the second electronic device, upon the second electronic device receiving the response signal. In an embodiment, the first electronic device may further comprise a first communication module, coupled to the first control module, wherein the first control module is configured to receive the file through the first communication module. In an embodiment, the second electronic device may comprise a second touch screen, a second control module and a second communication module, the first communication module may communicate with the second electronic device under at least one of Bluetooth, an infrared communication technology standard, a WLAN standard, or a Wi-Fi standard.

In an embodiment, the first touch screen is also configured to generate a second touch signal in response to receiving a touch scroll inward movement by the first object from an outer part on the first touch screen, and the first control module is also configured to issue a response signal according to the second touch signal and a signal of transmitting issued by the second electronic device, and wherein the first control module is configured to receive the file from the second electronic device, upon the second electronic device receiving the response signal.

### BRIEF DESCRIPTION OF THE DRAWINGS

FIG. 1 is a block diagram of a communication system having a file transmission function of the present invention;

FIG. 2 is a schematic view of a communication system having a file transmission function of the present invention; and

FIG. 3 is a flow chart of a file transmission method of the present invention.

### DETAILED DESCRIPTION OF THE PREFERRED EMBODIMENTS

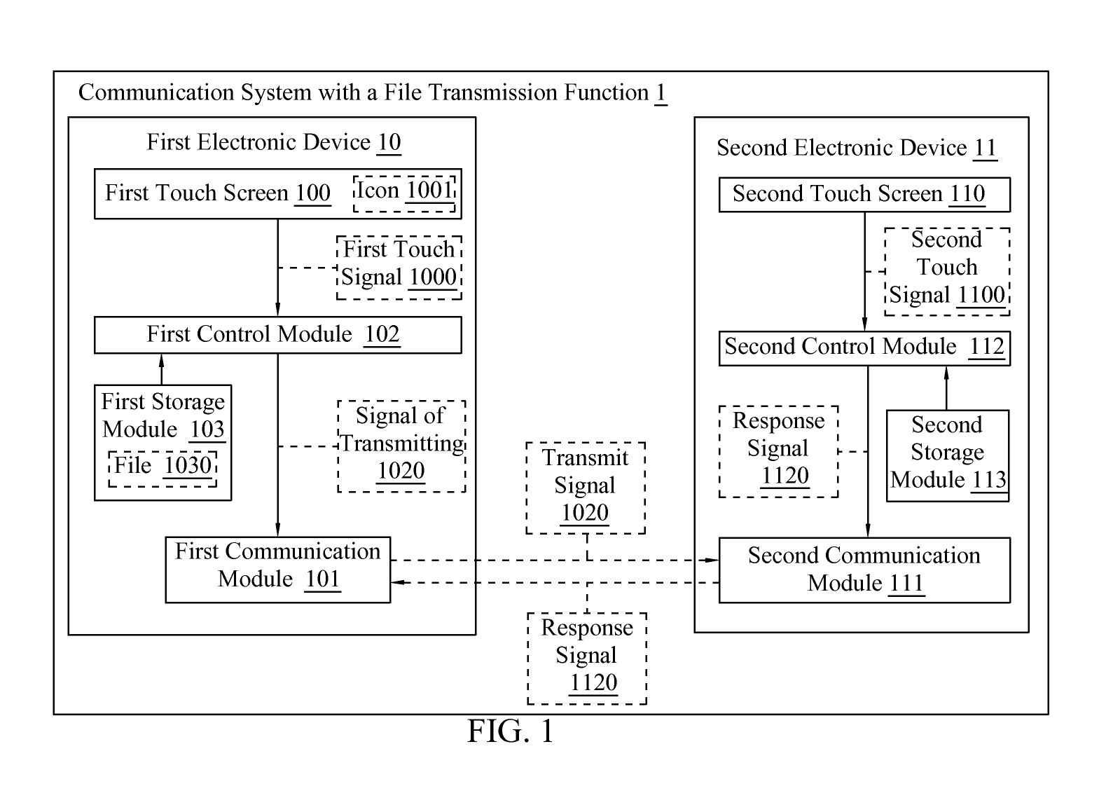

With reference to FIG. 1 for a block diagram of a communication system having a file transmission function in accordance with the present invention, the communication system having a file transmission function 1 may comprise a first electronic device 10 and at least one second electronic device 11. The first electronic device 10 may comprise a first touch screen 100, a first communication module 101, a first control module 102 and a first storage module 103. The second electronic device 11 may comprise a second touch screen 110, a second communication module 111, a second control module 112 and a second storage module 113. Wherein, the first storage module 103 and the second storage module 113 can be different storage media such as embedded memories, external memory cards, floppy disks or optical disk, and the first storage module 103 is provided for storing a file 1030. The first communication module 101 may communicate with the second communication module 111 through at least one of Bluetooth, an infrared communication technology standard, a wireless LAN standard, or a Wi-Fi standard. The first control module 102 and the second control module 112 may be central processing units (CPU) or micro-processing units, but the present invention is not limited to such arrangement only.

If a user A wants to use the first electronic device 10 to transmit the file 1030 (such as a photo, a MP3 song, a video file) to the second electronic device 11, the user A can use a first object (such as a finger or a touch pen) to perform an operation on the first touch screen 100. The operation is described as follows: The first object may be used for perform a touch scroll outward movement on the first touch screen 100, and the first touch screen 100 may generate a first touch signal 1000, wherein the first touch screen 100 can display the icon 1001 (such as a figure or a filename) of the file. The touch scroll movement may comprise touching anywhere on the icon and moving it, for example, touching on the icon and moving to the right without leaving the touch screen. And outward means the moving direction is oriented from the center part of the touch screen to the periphery of the touch screen. The first control module 102 may issue a signal of transmitting 1020 according to the first touch signal 1000, and the first control module 102 may issue the signal of transmitting 1020 to the second control module 112 through the first communication module 101. If a user B wants to receive the file 1030 by the second electronic device 11, the user B can use a second object (such as a finger or a touch pen) to operate on the second touch screen 110. In the operation, a touch scroll inward movement of the second object on the second touch screen 110 may be performed, and then the second touch screen 110 will generate a second touch signal 1100. Similar to the touch scroll outward movement, the touch scroll inward movement means touching on the icon and moving from the periphery of the touch screen to the center part of the touch screen. Consequently, the second control module 112 may issue a response signal 1120 according to the second touch signal 1100 and a signal of transmitting 1020, and the second control module 112 may issue a response signal 1120 to the first control module 102 through the second communication module 111. After the first control module 102 receives the response signal 1120, the first control module 102 may control the first communication module 101 to transmit the file 1030 to the second control module 112. The first control module 102 may further control the second storage module 113 to store the file 1030. Therefore, files can be transmitted by the intuitive operations to improve the convenience of transmitting files and enhance the utility of the electronic device in the industry.

In an embodiment, the first electronic device 10 and at least one second electronic device 11 can be a mobile phone, a notebook computer, a PDA and any combination of the above, but the present invention is not limited to the foregoing arrangements only, and the types and model numbers of the electronic devices can be set by the users as required.

In an embodiment, such the behavior of the touch scroll movement on the touch screen may be like to change the position of an icon associated with a file or a photograph on an iphone or an ipad.

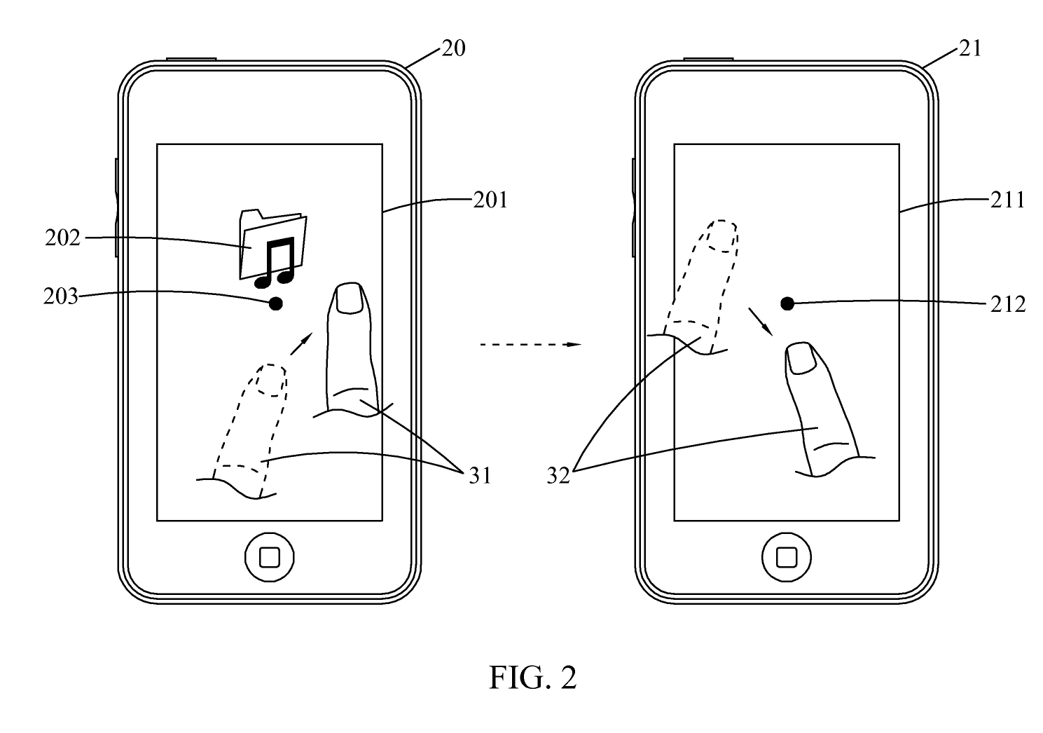

With reference to FIG. 2 for a schematic view of a communication system having a file transmission function in accordance with the present invention, the communication system having a file transmission function 1 may include personal digital assistants (PDA) 20, 21. In FIG. 2, the touch screen 201 of the PDA 20 may display an icon 202 associated with a file. When a user A wants to transmit the file 202 associated with the icon by the PDA 20 to the PDA 21, the user A may turn on the Bluetooth transmission device of the PDA 20 and starts searching Bluetooth electronic devices near the PDA 20. After the PDA 20 finds the PDA 21, the user A can use a finger 31 to perform a scroll movement on the touch screen 201. It is noteworthy to point out that the scroll movement is from a position near a center point 203 of the touch screen 201 to a position away from the center point 203 (as shown in the figure). Then, a user B can use a finger 32 to perform a scroll movement on the touch screen 211, such as scrolling from an edge of the touch screen 211 to a position near the center point 212 of the touch screen 211, such that files can be transmitted between the two PDAs through intuitive operations, so as to overcome the inconvenient operation of the prior art that requires selecting the files and then the target device through a function table. Obviously, the invention can improve the convenience of use.

In an embodiment, the fingers 31, 32 can be the same finger or different fingers, and can be substituted by a touch pen, and thus the types of the first object and second object of the present invention are not limited to those mentioned above only.

It is noteworthy to point out that the foregoing two electronic devices can be used to describe the concept of the present invention, but those ordinarily skilled in the art can apply the invention to a plurality of electronic devices, so that users can transmit files to many electronic devices at the same time via a multitasking process. In addition, the personal digital assistant (PDA) may be used as an example, but the scope of the present invention is not limited to PDA only, but it can be applied to any other electronic device such as a mobile phone, a notebook computer, a PDA and any combination of the above, as needed.

Even the concept of the file transmission method of the present invention has been described in the section of the communication system having a file transmission function already, the following flow chart can be provided for describing and illustrating the invention clearly.

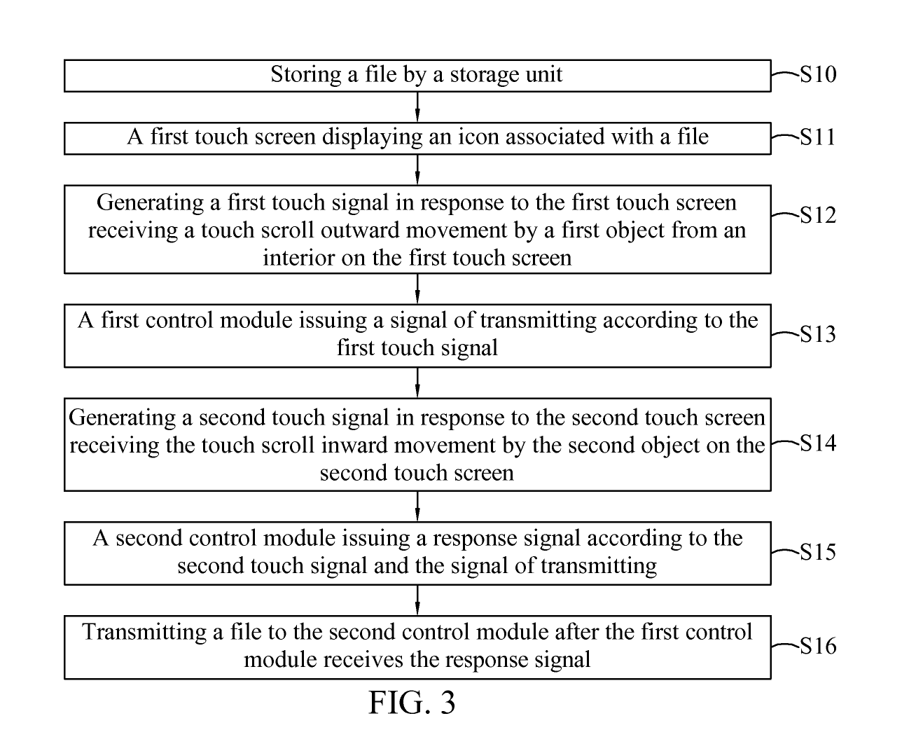

With reference to FIG. 3 for a flow chart of a file transmission method in accordance with the present invention, the file transmission method comprises the following steps:

S10: Storing a file by a storage unit.

S11: A first touch screen displaying an icon associated with a file.

S12: Generating a first touch signal in response to the first touch screen receiving a touch scroll outward movement by a first object from an interior on the first touch screen.

S13: A first control module issuing a signal of transmitting according to the first touch signal.

S14: Generating a second touch signal in response to the second touch screen receiving the touch scroll inward movement by the second object on the second touch screen.

S15: A second control module issuing a response signal according to the second touch signal and the signal of transmitting.

S16: Transmitting a file to the second control module after the first control module receives the response signal.

In an embodiment, the first control module and the second control module may transmit/receive a file through the first communication module and the second communication module respectively.

In another embodiment, a first electronic device 10 is capable of communicating a file 1030 with a second electronic device 11. The first electronic device 11 comprises a first touch screen 100, a first control module 102 and a first communication module 101. The first touch screen 100 may be configured to display an icon 1001 associated with a file 1030, and to generate a first touch signal 1000 in response to receiving a touch scroll outward movement by a first object 31 from an interior on the first touch screen 100. Wherein, the first touch signal 1000 is to be generated in response to the first touch screen 100 receiving the touch scroll outward movement by the first object 31 from around a first center point to an edge on the first touch screen 100. The first control module 102 is coupled to the first touch screen 100 and configured to issue a signal of transmitting according to the first touch signal 1000, wherein the first control module 102 may be configured to transmit the file 1030 to the second electronic 11 device upon receiving a response signal 1102 issued by the second electronic device 11 according to the signal of transmitting. The first communication module 101 is coupled to the first control module 102, wherein the first control module 102 is configured to transmit and to receive the file 1030 through the first communication module 101. Wherein, the first communication module 101 communicates with the second electronic device 11 under at least one of Bluetooth, an infrared communication technology standard, a WLAN standard, or a Wi-Fi standard. The second electronic device 11 comprises a second touch screen 110, a second control module 112 and a second communication module 111. The second touch screen 110 may be configured to generate a touch signal in response to receiving a touch scroll inward movement by a second object 32 from an outer part on the second touch screen. The second control module 112 is coupled to the second touch screen 110 and configured to issue the response signal 1120 according to the touch signal and the signal of transmitting. The second communication module 111 is coupled to the second control module 112, wherein the second control module 112 is configured to receive the file 1030 through the second communication module 111.

It is noteworthy to point out that the first touch screen 100 is also configured to generate a touch signal in response to receiving a touch scroll inward movement by the first object from an outer part on the first touch screen 100, and the first control module 102 is also configured to issue a response signal according to the second touch signal and a signal of transmitting issued by the second electronic device 11, and wherein the first control module 102 is configured to receive the file from the second electronic device 11, upon the second electronic device 11 receiving the response signal. In an embodiment, the second touch screen 110 generates a first touch signal in response to receiving a touch scroll outward movement by a second object from an interior on the second touch screen 110. The second touch signal is to be generated in response to the first touch screen 100 receiving the touch scroll inward movement by the first object from an edge to around a first center point on the first touch screen 100. The second control module 112 issues the signal of transmitting according to the touch signal and transmits the file to the first electronic device 10 upon receiving the response signal issued by the first electronic device 10 according to the signal of transmitting issued by the second control module 112. Finally, the second control module 112 transmits the file through the second communication module 111 to the first electronic device 10.

The function and operation of the components described in the aforementioned steps are the same as those described in the communication system having a file transmission function of the present invention, and thus will not be repeated.

The present invention is described and illustrated by the foregoing preferred embodiment, but each module can be implemented by software or hardware components or operated together with necessary solid components.

In summation of the description above, the file transmission method and the communication system having a file transmission function in accordance with the present invention overcome the shortcomings of the prior art with an inconvenient and tedious process which requires the operations of selecting a file through a function table and then selecting a desired transmitting device. The invention transmits files between the electronic devices by an intuitive scroll operation and improves the convenience of use.

While the invention has been described by means of specific embodiments, numerous modifications and variations could be made thereto by those skilled in the art without departing from the scope and spirit of the invention set forth in the claims.

What is claimed is:

1. A communication system having a file transmission function, comprising:
a first touch screen, configured to display an icon associated with a file and to generate a first touch signal in response to receiving a touch scroll outward movement by a first object from an interior on the first touch screen;
a first control module, coupled to the first touch screen and configured to issue a signal of transmitting according to the first touch signal;
a second touch screen, configured to generate a second touch signal in response to receiving a touch scroll inward movement by a second object from an outer part on the second touch screen; and
a second control module, coupled to the second touch screen and configured to issue a response signal according to the second touch signal and the signal of transmitting;
wherein the first control module transmits the file to the second control module, upon receiving the response signal.

2. The communication system as recited in claim 1, further comprising:
a first communication module, coupled to the first control module, wherein the first control module is configured to transmit the file through the first communication module; and
a second communication module, coupled to the second control module, wherein the second control module is configured to receive the file through the second communication module.

3. The communication system as recited in claim 2, wherein the first communication module communicates with the second communication module under at least one of Bluetooth, an infrared communication technology standard, a wireless local area network (WLAN) standard, or a wireless fidelity (Wi-Fi) standard.

4. The communication system as recited in claim 1, wherein the first touch signal is to be generated in response to the first touch screen receiving the touch scroll outward movement by the first object from around a first center point to an edge on the first touch screen.

5. The communication system as recited in claim 1, wherein the second touch signal is to be generated in response to the second touch screen receiving the touch scroll inward movement by the second object from an edge to around a second center point on the second touch screen.

6. A method for transmitting a file, applicable to a first electronic device and a second electronic device, the first electronic device comprising a first touch screen and a first control module, the second electronic device comprising a second touch screen and a second control module, and the method comprising the following steps of:
the first touch screen displaying an icon associated with the file;
the first touch screen receiving a touch scroll outward movement by a first object from an interior on the first touch screen, and generating a first touch signal in response;
the first control module issuing a signal of transmitting according to the first touch signal;
the second touch screen receiving a touch scroll inward movement by a second object from an outer part on the second touch screen, and generating a second touch signal in response;
the second control module issuing a response signal according to the second touch signal and the signal of transmitting; and
the first control module transmitting the file to the second control module, upon receiving the response signal.

7. The method for transmitting a file as recited in claim 6, wherein the step of the first control module transmitting the file is through a first communication module, and the second control module is configured to receive the file through a second communication module.

8. The method for transmitting a file as recited in claim 7, wherein the first communication module communicates with the second communication module under at least one of Bluetooth, an infrared communication technology standard, a WLAN standard, or a Wi-Fi standard.

9. The method for transmitting a file as recited in claim 6, wherein the step of the first touch screen receiving the touch scroll outward movement comprises the first touch screen receiving the touch scroll outward movement by the first object from around a first center point to an edge on the first touch screen.

10. The method for transmitting a file as recited in claim 6, wherein the step of the second touch screen receiving the touch scroll inward movement comprises the second touch screen receiving the touch scroll inward movement by the second object from an edge to around a second center point on the second touch screen.

11. A first electronic device capable of communicating a file with a second electronic device, the first electronic device comprising:
a first touch screen, configured to display an icon associated with a file, and to generate a first touch signal in response to receiving a touch scroll outward movement by a first object from an interior on the first touch screen; and
a first control module, coupled to the first touch screen and configured to issue a signal of transmitting according to the first touch signal, wherein the first control module is configured to transmit the file to the second electronic device upon receiving a response signal issued by the second electronic device according to the signal of transmitting.

12. The first electronic device as recited in claim 11, with the second electronic device comprising:
a second touch screen, configured to generate a touch signal in response to receiving a touch scroll inward movement by a second object from an outer part on the second touch screen;
a second control module, coupled to the second touch screen and configured to issue the response signal according to the touch signal and the signal of transmitting; and
a second communication module, coupled to the second control module, wherein the second control module is configured to receive the file through the second communication module.

13. The first electronic device as recited in claim 11, wherein the first touch signal is to be generated in response to the first touch screen receiving the touch scroll outward movement by the first object from around a first center point to an edge on the first touch screen.

14. The first electronic device as recited in claim 11, wherein the first touch screen is also configured to generate a second touch signal in response to receiving a touch scroll inward movement by the first object from an outer part on the first touch screen, and the first control module is also configured to issue a response signal according to the second touch signal and the signal of transmitting issued by the second electronic device, and wherein the first control module is configured to receive the file from the second electronic device, upon the second electronic device receiving the response signal.

15. The first electronic device as recited in claim 14, further comprising a first communication module, coupled to the first control module, wherein the first control module is configured to transmit and to receive the file through the first communication module.

16. The first electronic device as recited in claim 15, wherein the first communication module communicates with the second electronic device under at least one of Bluetooth, an infrared communication technology standard, a WLAN standard, or a Wi-Fi standard.

17. The first electronic device as recited in claim 14, with the second electronic device comprising:
a second touch screen, configured to generate the touch signal in response to receiving a touch scroll outward movement by a second object from an interior on the second touch screen;
a second control module, coupled to the second touch screen and configured to issue the signal of transmitting according to the touch signal, wherein the second control module is configured to transmit the file to the first electronic device upon receiving the response signal issued by the first electronic device according to the signal of transmitting issued by the second control module; and
a second communication module, coupled to the second control module, wherein the second control module is configured to transmit the file through the second communication module.

18. The first electronic device as recited in claim 14, wherein the second touch signal is to be generated in response to the first touch screen receiving the touch scroll inward movement by the first object from an edge to around a first center point on the first touch screen.
